(19) United States
(12) Patent Application Publication
(10) Pub. No.: US 2007/0015131 A1
(43) Pub. Date: Jan. 18, 2007

(54) Extracorporeal organ conservation

(76) Inventors: Joachim Arzt, Reichenbach (DE); Albrecht Gnuechtel, Mannheim (DE); Christine Thiele, Dresden (DE); Michael Schoen, Leipzig (DE)

Correspondence Address: BOHAN, MATHERS & ASSOCIATES, LLC, PO BOX 17707, PORTLAND, ME, 04112-8707, US

(21) Appl. No.: 10/570,835

(22) PCT Filed: Sep. 2, 2004
(86) PCT No.: PCT/DE04/01944

§ 371 Date: May 19, 2006

(30) Foreign Application Priority Data
Sep. 3, 2003 (DE) 103 40 488.0

(51) Int. Cl. A01N 1/02

(52) U.S. Cl. 435/1.1

(57) ABSTRACT

Storage system for extracorporeal storage of organs. The storage system artificially maintains or regenerates the vital functions of organs, including limbs and tissue lobes. The storage system comprises an organ perfusion chamber filled with dialysate as a storage fluid and equipped with a temperature control device that maintains the temperature of the storage fluid. The organ stored in the perfusion chamber is covered by a protective cover and maintained in a completely floating state in the storage fluid.

### BACKGROUND INFORMATION

1. Field of the Invention

The invention relates to a system for extracorporeal storage of organs, for artificially preserving or regenerating the vital functions of organs intended for transplant surgery. An important field of use is, in particular, the transport of organs or, generally, biochemical or pharmacological study of isolated organs.

2. Description of the Prior Art

As used herein, the term “organ” shall also include limbs and tissue lobes and the like; hence, “organ” is used as a generic term. Devices for the perfusion of isolated organs are known. Schoen, M. R. discloses a perfusion device that is a fluid-filled, closed organ perfusion chamber with cyclic pressure fluctuations for normothermal extracorporeal liver perfusion. See: “Transplantation von Lebern nicht-herzschlagender Spender im Schweineleber-Transplantationsmodell,” Habilitationsschrift 1999, Humboldt Universitaet zu Berlin. Water heated to about 37 degrees C. in an external heat exchanger flows through the organ perfusion chamber. This circulation is needed, in addition to the perfusion circulation and the dialysate circulation.

### BRIEF SUMMARY OF THE INVENTION

It is the aim of the present invention to provide the simplest possible construction of a system for the extracorporeal storage of organs. In organ transplant surgery, organ and transplant logistics has become in part a global operation and transporting and preserving the functional ability of the organs is a particularly important task of logistics.

According to the invention, this object is achieved by providing a storage system for extracorporeal storage of organs comprising an organ perfusion chamber with a temperature control device.

An organ, covered by a protective cover, is stored in the organ perfusion chamber. The protective cover is preferably an impermeable plastic bag. The organ thus protected is maintained in a completely floating state in the storage fluid.

The underlying concept of the invention is to use as the storage fluid the dialysate, which is already available. The dialysate is an essential component for preserving the vital functions of the organ and, as such, is also an essential component of the circulation system for preserving vitality. This circulation system comprises a dialysate circulation system and a perfusate circulation system, which supply the extracorporeal organ. According to the invention, the required dialysate circulation and the necessary aggregates are used to integrate the storage fluid as dialysate in the dialysate circulation and at the same time to use the organ perfusion chamber as a reservoir for the dialysate.

The organ perfusion chamber is hermetically sealed against liquid and pressure. Not only is it important for medical reasons to seal the chamber, but it also is particularly important to do so if the organ is to be transported by plane or helicopter.

The wall of the organ perfusion chamber, the protective cover, and the dialysate are transparent. A temperature control device provides the normothermal or hypothermal ambient temperature for the extracorporeal organ. The temperature control device is preferably provided in the form of a heating mat that is placed on the floor of the organ perfusion chamber. The flow of the dialysate ensures that the isolated organ is maintained at an even temperature. In another preferred embodiment of the invention, the temperature device is integrated into the wall of the organ perfusion chamber as heating and cooling loops. Multiple measuring probes or sensors record characteristics and parameters, such as, for example, fluid level, pressure, temperature. Signals from the probes or sensors may be made available for processing for presentation on a display device or for digital process control.

### BRIEF DESCRIPTION OF THE DRAWING

FIG. 1 is a schematic illustration of a system according to the invention for the extracorporeal storage of an organ.

### DETAILED DESCRIPTION OF THE INVENTION

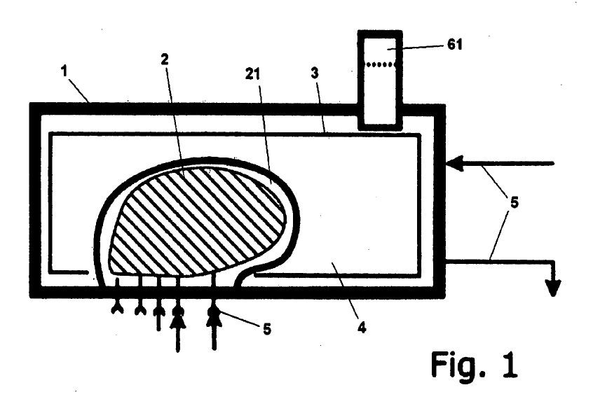

FIG. 1 schematically depicts an example of one embodiment of a storage system 100 for the extracorporeal storage of organs. The storage system comprises a transparent organ perfusion chamber 1. The organ perfusion chamber is hermetically sealed against fluid and pressure with quick-release fasteners (not shown). In this embodiment, an organ 2 is stored at normothermal temperature in a storage fluid 4. The organ 2 shown in the illustration is a liver, but it is understood that the term organ is used herein broadly to refer to internal organs, as well as limbs, tissue lobes, and the like. As shown, a protective cover 21 within the organ perfusion chamber 1 receives and covers the organ 2, effectively protecting it from the storage fluid 4, yet allowing exposure to a vitality-preserving circulation system 5. The protective cover 21 is, for example, an impermeable, transparent plastic bag.

The covered organ 2 is maintained in a completely floating state in the storage fluid 4. The storage fluid 4 is a dialysate and is a component of the vitality-preserving circulation system 5. A temperature control device 3 is provided in the organ perfusion chamber 1. In this embodiment, the temperature control device 3 is a heating mat. Other suitable temperature control systems include heating or refrigeration loops integrated into the wall of the perfusion chamber 1. Multiple measuring probes or sensors 6 supply signals for a process control. A fluid level indicator 61 indicates the level of the storage fluid 4. The fluid-level indicator 61 shown in the embodiment is a riser, which, for purposes of illustration, has been rotated 90 degrees. It is actually disposed vertically in the organ perfusion chamber 1 and extends perpendicular to the plane of the drawing sheet.

1-4. (canceled)

5. A storage system for extracorporeal storage of organs, said storage system comprising:
an organ perfusion chamber;
a vitality-preserving fluid circuit for circulating a vitality-preserving fluid into an organ stored in said organ perfusion chamber, wherein said vitality-preserving fluid includes a dialysate circuit; and
a storage fluid that fills said organ perfusion chamber, wherein said storage fluid is a dialysate and wherein said organ perfusion chamber serves as a reservoir for said dialysate that is added to said dialysate circuit as needed.

6. The system of claim 5 further comprising a temperature control device within said organ perfusion chamber for controlling temperature of said storage fluid in said organ perfusion chamber.

7. The system of claim 6, wherein said temperature control device is a heating mat.

8. The system of claim 6, wherein the temperature control device is integrated into the wall of the organ perfusion chamber.

9. The system of claim 8, wherein the temperature control device comprises temperature-control loops embedded with a wall of said organ perfusion chamber.

10. The system of claim 5, wherein said organ perfusion chamber is hermetically sealed against fluid and pressure.
